(19) United States
(12) Patent Application Publication
(10) Pub. No.: US 2005/0166041 A1
(43) Pub. Date: Jul. 28, 2005

(54) Authentication in a distributed computing environment

(75) Inventor: Aaron Charles Brown, Ottawa (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(73) Assignee: Gridlron Software, Inc.

(21) Appl. No.: 11/038,146

(22) Filed: Jan. 21, 2005

Related U.S. Application Data
(60) Provisional application No. 60/538,281, filed on Jan. 23, 2004.

(51) Int. Cl. H04L 9/00

(52) U.S. Cl. 713/150

(57) ABSTRACT

A distributed computing environment providing mechanisms to remedy lack of authentication, lack of authorization, lack of confidentiality, insecure configuration and system compromise is described.

### CROSS REFERENCE TO RELATED APPLICATIONS

This application claims the benefit of U.S. Provisional Application No. 60/538,281, filed Jan. 23, 2004 which is incorporated by herein reference.

### FIELD OF THE INVENTION

The present invention relates generally to authentication technologies. More particularly, the present invention relates to authentication in a distributed computing environment of peers, distributed applications and the distribution of the computing environment.

### BACKGROUND OF THE INVENTION

Many software applications require the combined resources of a number of computers, which are connected together through standard and well-known networking techniques (such as TCP/IP networking software running on the computers and on the hubs, routers, and gateways that interconnect the computers). In particular, Grid or Cluster-based high performance computing solutions make use of a network of interconnected computers to provide additional computing resources necessary to solve complex problems. Building such an environment without regard to security leaves the systems vulnerable to computer viruses of various types.

In conventional grid computing networks, a number of nodes are connected to a central node, which is used to distribute job slices to the other nodes. This creates a hierarchical architecture, with a centralized master node and a pool of distributed computing power in a series of slaved nodes. An example of this architecture is the “render farm” setup used in the animation of digital characters.

In this architecture, a slaved node receives a job slice from the central node and begins its assigned task. These networks are assumed to be secure, and if authentication of a job is required, the slave node simply checks to see that the node that it is receiving a job slice from is the predetermined central node. This can be done by checking a network address. Though this provides a form of job authentication it also results in a centralized point of failure, as any node that can successfully impersonate the central node can then submit tasks to the slaved nodes.

In another style of grid computing, a series of distributed slaved nodes are directed to connect to the source node, by use of http or another such network protocol, and each slaved node obtains its application and job slice from the source node by issuing a request to the source node. The application distributed to each slaved node is designed to connect to the source node and request job slices. Examples of this architecture include distributed computing projects such as SETI@Home, the Great Internet Mersenne Prime Search and GoogleComputes. In this architecture, the slaved node does not authenticate the job received from the source, because it initiated contact with the source to obtain a job slice. The assumption is made that the central node is secure, and that the job slice obtained from the central node has not been tampered with, either at the source or in transit.

In conventional grid networks, the mechanism for determining the authenticity of a job is an address check that determines that job has been received from the predetermined source node. The only guarantee provided by an address or name based authentication is that the job is being received from the correct source. If the source node has been subject to an attack, the job slices may have been corrupted. If a malicious third party can sufficiently impersonate the central node, they can also deliver job slices to the slaved nodes that will bypass existing authentication systems. This is clearly an undesirable result, and a mechanism for authentication of a job that does not rely upon a name or address of the submitting node would be advantageous.

In peer-to-peer grid networks, there is no centralized source for jobs; any peer in the grid can submit jobs. With such a topology, there is no convenient mechanism to allow a peer to authenticate that a job was received from another peer, as in large distributed environments it is not feasible for each peer to have a list of all other peers in the grid. In an environment where the peers in the grid are also general purpose computers that are used to execute other, non-grid related, tasks, a node can be hijacked and then used to submit invalid jobs. Malicious third parties can also attempt to impersonate a peer and submits jobs into the grid. It would be desirable to have an authentication system that does not rely upon verifying the address or name of the submitting node.

In a typical peer-to-peer distributed computing environment a network of peers is established, and a distributed application is distributed among them. Often this is described as parcelling out job slices. Typically, each peer will accept a job slice from any application being executed by the distributed computing environment. If a peer is designated as a distribution node it typically accepts any job divided into slices for distribution, and any task for execution. Conventionally, job components contain no declaration of origin and cannot be authenticated to be safe. To allow for simple remapping of resources, peers are typically not locked into a configuration, and as a result, and have no mechanism for authenticating other nodes in the grid.

Distributed applications can be created and distributed quickly within a grid or cluster computing network. Typically these networks do not provide an implicit or explicit security framework. Peers in these networks typically make no attempt to verify either the job to-be-distributed or the task to-be-executed, nor do they protect the integrity of data transferred between each peer or verify the correctness of the persistent configuration data. Such peers are perfect instruments for enabling distribution of “Trojan Horse”-style attack applications.

Many peers in distributed computing environments are configured to run as a service of a local user account, accepting jobs and tasks for execution. When executed by the peer, task distributors and task executors inherit the permissions of the local user account under which they are run. If allowed to be executed without the constraints of an execution sandbox, distributors and executors are allowed access to all the resources that the local user account already has access to.

One of the high-level security issues within the conventional grid computing frameworks is a lack of authentication of jobs.

Authentication is the process of verifying that an entity is genuine, based on qualities which were previously known to be trustworthy. A trusted relationship can only be established between entities that are able to independently verify each other using explicit or derived characteristics. A lack of authentication exists within 3 areas of typical distributed computing environments: distribution of the environment, the application executed and entities claiming to be peers.

In the case of the distribution of the environment, one is encouraged to examine the scenario where a user wants to make use local network computing resources and decides to install a peer-to-peer distributed computing environment. The user is directed to a distribution node, such as an Internet website, and after providing contact information for registration, downloads a distributed computing environment. The user installs the downloaded distribution on all local hosts. The scenario raises the issue of whether or not the user was actually obtaining the environment from the distribution node or from an imposter, as well as the issue of whether or not the distribution the user downloaded was a legitimate package. There are no mechanisms presently in place to provide a proof of authenticity for either the distribution node or a distributed computing environment platform distribution. With ownership of a distribution site, an attacker could intercept and hijack traffic to and from the site, archive data for replay, and/or provide bogus data in place of genuine data. A compromised distribution site would allow for the replacement of a legitimate distribution. A user cannot distinguish from a legitimate distribution and a compromised distribution. A compromised distribution could perform any action on a host during installation that a user account, either actively or passively, grants permission for.

In the case of an application executed within a distributed computing environment, one is encouraged to examine the scenario where a user obtains a distributed environment-enabled application and wants to make use of the distributed computing capabilities of an already installed grid. The user installs the grid-enabled application and executes it on a peer in the grid. The scenario raises the issue of whether the executed application is a recognized grid-enabled application. There are no mechanisms in place in conventional grid computing environments to provide a proof of authenticity for grid-enabled applications. A peer in the grid cannot distinguish between a ‘legitimate’ application and a ‘harmful’ application. A harmful application could perform any action on a host during execution that the local users account the peer is running under.

In the case of authentication of entities claiming to be peers, consider the scenario where a job is submitted to a grouping of peers in a grid. Each peer is assigned application tasks, and each task is sent application data. This raises the question of whether the data has been sent to a valid peer, or if it has been sent to an entity masquerading as a peer. Conventional distributed computing environments provide no mechanisms to provide a proof of authenticity for a peer within a deployed grid. A peer cannot distinguish between a ‘legitimate’ peer and a ‘mock’ peer. A mock peer could collect application data by participating as a seemingly valid peer. Collected data could be transferred remotely or archived locally for later retrieval.

At present, it can be assumed that if a job can be authenticated as being approved by a trusted entity, it is safe to execute. A lack of job authentication eliminates the ability to determine if a job is trusted, or if it has been corrupted, either intentionally or unintentionally, in transit from a trusted source.

It is, therefore, desirable to provide a system capable of authenticating jobs in a distributed computing environment.

### SUMMARY OF THE INVENTION

It is an object of the present invention to obviate or mitigate at least one disadvantage of previous grid computing based job authentication mechanisms.

In a first aspect of the present invention, there is provided a method of authenticating a job at one of a plurality of nodes in a grid computing network. The method comprises the steps of receiving a job at the node; associating the job with a locally stored application in accordance with a job characteristic; and comparing a security feature of the job with a security feature of the locally stored application.

In an embodiment of the first aspect of the present invention, the step of receiving the job includes receiving a job at a local input for distribution to at least one of the plurality of nodes in the grid computing network, and the step of comparing includes verifying that the job has been signed with a digital signature associated with the security feature associated with the locally stored application. In further embodiments, the step of verifying includes determining that the job has been signed with a digital signature associated with one of a verification certificate and a public key associated with the locally stored application. In another embodiment, the step of comparing includes verifying that a fingerprint of the job has been signed with a digital signature associated with one of a verification certificate and a public key associated with the locally stored application and the method further includes the steps of forwarding the job to a job distribution node in the plurality of nodes when the comparison identifies complementary security features and generating an error message when the comparison fails to identify complementary security features.

In a second embodiment of the first aspect of the present invention, the step of receiving the job including receiving a job from an application submission node, in the plurality of nodes, for distribution, as job slices, to at least one other node in plurality of nodes. In other embodiments, the step of comparing includes verifying that the security feature of the job is complementary to the security feature of the locally stored application. In another embodiment, the step of dividing the received job into job slices when the comparison identifies complementary security features and the method further includes the step of distributing the job slices to at least one of the plurality of nodes in the grid computing network. In another embodiment, the method includes the steps of generating an error message when the comparison fails to identify complementary security features; and transmitting the generated error message to the application submission node. In another embodiment, the step of receiving includes forming a connection to a job control module of the application distribution node and receiving the job over the formed connection and the step of comparing includes verifying that the job control module and the application have complementary security features.

In a further embodiment of the first aspect of the present invention, the step of receiving the job includes receiving a job slice from a job distribution node in the plurality of nodes. In another embodiment, the step of comparing includes verifying that the security feature of the job and the security feature of the locally stored application are complementary. In a further embodiment, the method includes the step of executing the job slice using the locally stored application when the comparison indicates complementary security features. In another embodiment, the method includes
generating an error message when the comparison fails to indicate complementary security features; and transmitting the generated error message to the job distribution grid. In further embodiments, the step of receiving includes forming a connection to a task distribution module of the job distribution node and receiving the job slice over the formed connection, and the step of comparing includes verifying that the task distribution module and the locally stored application have complementary security features.

In a second aspect of the present invention, there is provided a node in a grid computing network. The node comprises an input, a comparator and a job engine. The input receives a job. The comparator compares a security feature associated with the job to a known security feature and generates a comparison message in accordance the comparison of the security features. The job engine acts on the job when the comparison message indicates the security features are complementary. In various embodiments, the input includes means to receive the job from a local application, and the job engine includes means to separate the job into job slices and forward the job slices to another node in the grid computing network for distribution; the input includes means for receiving job slices for distribution, and the job engine includes means for distributing the job slices to at least one other node; and the input includes means to receive a job slice and the job engine includes means for executing the job slice. In a further embodiment, the node includes a message interface for transmitting error messages when the comparison signal indicates the security features are not complementary.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 the connection of nodes in an embodiment of the present invention;

FIG. 2 is a flow chart illustrating a method of the present invention;

FIG. 3 is a data flow illustrating an application authentication failure;

FIG. 4 is a data flow illustrating a task distributor authentication failure; and

FIG. 5 is a data flow illustrating a task executor authentication failure.

### DETAILED DESCRIPTION

Generally, the present invention provides a method and system for providing authentication of jobs in a distributed computing environment.

In the description of the present invention, reference will be made to a distributed computing environment based upon a peer-to-peer network topology. One skilled in the art will appreciate that the authentication system and method of the present invention can be applied to both peer-to-peer and hierarchical topologies.

In a peer-to-peer network topology, a grid prime is designated from among the nodes in the grid. The grid prime holds a list identifying the nodes in the grid. Each node in the grid knows the prime. One skilled in the art will appreciate that there may be more than one grid prime per grid, and that in such a case, each peer will know at least one of the primes in the grid. Any of the nodes in the grid can submit a job for execution by the peers. The node that distributes the job slices initiates contact with the prime to obtain a list of peers that can dedicate resources to a job. A list of peers for a job is created, and the distributing node contacts each peer in the list and initiates the job distribution.

Often the job is a series of parameters that are to be executed by an application that the distributing node provides each node. The application, and any other data parameters that are transferred to the other peers in the list, can be transferred using any of a number of known techniques for local storage. For the purposes of simplicity, it will be assumed that an application and any required data have already been distributed to the various nodes.

The need for authentication arises from the fact that the distributed job is initiated by a single node, and is then executed by another node. Depending on the network topology, the application may not be distributed by the same node that is submitting the job. Thus, there can be a submitting node, at least one distributing node, and at least one executing node. In a true peer-to-peer setup, any node in the grid can serve any one, or more, of the above roles. As a direct result, name or address based authentication cannot be successfully employed without an unwieldy setup that provides each node with a list of all nodes in the grid.

As different nodes can perform each the job submission, job distribution and job execution, each node in the chain can authenticate that no node before it has provided a corrupted, or unauthenticatable, job. If a failure is detected it can be returned through the job distribution chain as an error message.

From the perspective of a peer receiving a job slice, there are two elements that can be authenticated. The job itself can be authenticated, as can the distribution of the job. Where the application has previously been supplied to the peer, the peer can obtain from the application a signature. This signature, which is associated with the application itself, can be used to authenticate any job calling the supplied application.

Upon receipt of a job slice, the peer can first verify that the task distributor is utilizing distribution libraries signed by either the same party that signed the application, or by a party that can show a trust relationship to the party that signed the application. If the task distribution cannot be authenticated, the peer can decline to execute the job slice, and provide an execution error message up through the application chain.

If the task distribution can be authenticated, the job slice can then be subjected to an authentication procedure. To authenticate the job slice, the peer can examine a signature applied to either the job slice, or to a component transmitted along with the job slice. This signature can be compared to the signature associated with the locally stored application. If the job slice itself fails the authentication, the job slice is declined and an execution error message is transmitted through the application chain. To avoid signing the job slice, which may result in complex computations both at the signing and verification ends, a fingerprint of the job slice can be signed and transmitted along with the job slice. The signed fingerprint can then be verified as being signed by a trusted party and as being generated for the job slice. Upon successful verification of these parameters, the slice can be considered to be authenticated. To obtain a fingerprint, a number of known techniques can be employed, including conventional one-way hashing techniques.

At the job distribution node, an application submitted for distribution can be authenticated. The distribution application will have been previously supplied to the distribution node, along with a verification certificate. When a job is provided for distribution, the distribution node can verify that the application submitting the job is utilizing job control libraries signed by either the same party that signed the distribution application, or by a party that can show a trust relationship to the party that signed the application. In addition to authenticating the job control libraries of the submitting node, the job, or job slices can also be authenticated. If the job cannot be authenticated, the task distribution node can return a distribution error message to the application submission node, and then decline to distribute the application.

At the job submission node, an application is used to submit jobs into the grid. The application used to submit the job into the grid will have been previously installed, along with a signature. Any job designed for submission to the grid can be signed, in advance of its submission, by a separate application to allow it to be compared to the signature provided with the distribution application. Signing a job with the signature shared among the job submission, job distribution, and job execution elements, allows all nodes in the application chain to authenticate that the submitted job has been approved either by the same party that signed the components of the application chain, or by a party that can show a trust relationship to the party that signed the application chain components.

Multiple parties can be used to sign at each stage. To allow all nodes to verify signatures, each signing party signs an element with its own signature. The public verification certificate associated with that signature is then provided to a trusted third party that serves as a root for a certificate chain. The trusted third party then signs the verification certificate. The distributed application components are provided with the verification certificate of the trusted third party. When a job or job slice is received, verification proceeds first by verifying that the trusted third party has signed a verification certificate. The signed verification certificate is then used to verify the job or job slice. This establishes a verification chain that allows delegation of responsibility to other parties. The certificate chain can extend to more than two levels, if further delegations are required.

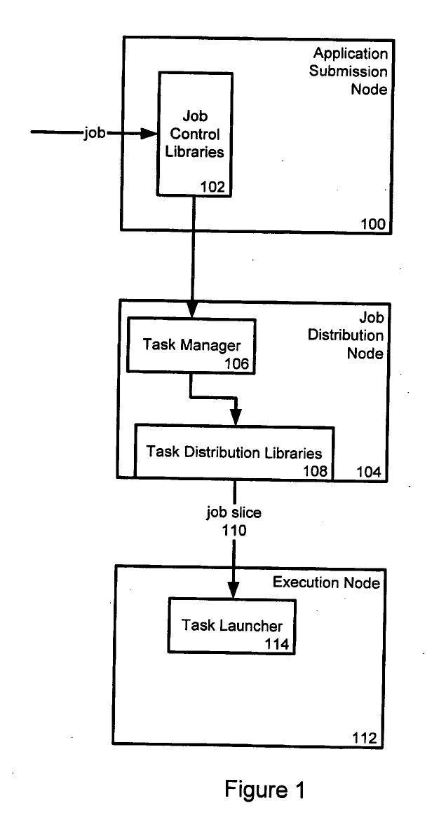

As an optional feature of peer-to-peer distributed grid topologies, each peer can function as any of the application submission node, the distribution node and the task execution node. FIG. 1 illustrates an exemplary embodiment of the present invention. To provide logical separation of functionality, the application submission node 100, includes an application component that makes use of a set of job control libraries 102. When a job is submitted, the job control libraries 102 are started, and the job is authenticated. If authentication fails there is an application authentication error that is provided to the local application component. Typically, this error is a fatal error, as the job control libraries 102 preferably will not allow a job to be started that cannot be authenticated.

If the job control libraries 102 can successfully authenticate the submitted job, the job is passed to the distribution node 104. One skilled in the art will appreciate that job submission and job distribution functions need not be performed by separate nodes, but they are described as such only from a logical perspective. If the grid topology does not permit the separation of application submission and job distribution, the job distribution functionality are preformed by the same node. In such an arrangement, authenticating the job submission portion of the process can optionally be omitted, as it is unlikely that the application was corrupted without leaving the node.

The distribution node 104 receives the job from the job control libraries 102 of the application submission node 100. The job, or task, is received by a task manager 106 of the distribution node 104. The task manager 106 authenticates the job using the signature and verification certificate associated with the application. If the authentication of the task fails, it is an indication that either the job was not signed prior to submission, or has been corrupted in transmission. Job distribution node 104 will then return an error message to application submission node 100. This error is typically considered fatal as it prevents the distribution of the job slices 110.

If task manager 106 successfully authenticates the job, task distribution libraries 108 are used to distribute job slices 1 10 to at least one execution node 112. The job slice is received by task launcher 114, which preferably authenticates both the task distribution libraries 108 and the job slice 110. One skilled in the art will appreciate that task launcher 114 can be designed to perform only one authentication without departing from the scope of the present invention. If authentication fails at task launcher 114, an error message can be sent up the chain to both job distribution node 104 and application submission node 100. This error need not be considered a fatal error, as other peers in the grid may not encounter the error, and can continue executing their job slices.

If authentication is successful at task launcher 114, the job slice is executed and results are returned. The results can be sent to application submission node 100 either directly or through job distribution node 104. The results can also be provided to another entity, if sufficient instruction is provided in job slice 110.

Only verified and validated job components (an application making use of job control, task distributor and executor components) are used within a grid of the present invention. Job components can be signed using such known techniques as detached PKCS #7 signatures (in the case of native applications), Microsoft Authenticode™ or signed JAR files. The job control libraries 102 of the application submission node 100 are verified at subsequent nodes by the locally stored application. The task distribution libraries 108 of the job distribution node 104 are verified, as job components configured for remote execution, by the execution node 112.

For any node in the grid computing network, a trusted third party (TTP) is preferably established during configuration of the node. By establishing a trusted third party in advance, all nodes are able to verify received jobs or job slices, and the libraries that they are received from, if applicable. The trusted third party can delegate its signing authority using a certificate chain as described above. The presence of the certificate chain to a trusted third party allows a node to identify another node as a trusted entity. A TTP such as GTE Corporation, RSA Security or VeriSign can be relied upon to perform the necessary background verification checks to confirm that the node can be bound to the entity, and a certificate is issued as proof of the binding. Thus, a node that already has a trusted relationship with a TTP can be assured that the job is being received by an entity that is who it claims to be.

To enable trust in gird computing environment distributions, a user must be able to determine that a job or job slice is a genuine product. In the same way that a TTP can vouch for the distribution site's authenticity, a TTP can be used to vouch for the authenticity of a particular distribution. A digital signature, intrinsic to the distribution, can be produced such that a user can compare the signature to a certificate issued previously by a TTP. A trust relationship between the user and the TTP who issued the certificate is already in place and forms the basis for the verification of the digital signature produced for the distribution.

The grid job control libraries 102 of the application submission node 100 preferably authenticate grid-enabled applications prior to submission. Before defining a job for execution, the grid job control libraries 102 must verify the invoking application against a trusted source of authentication information. The grid job control libraries 102 can compare the application's fingerprints against an existing set of fingerprints, or verify the application's digital signature.

Each peer, independent of the other cooperating peers in the grid, preferably authenticates grid-enabled application components. Application components include task distribution libraries 108, task launcher 114 and static application data. Before making use of an application component, a peer will preferably verify the component against a trusted source of authentication information. A peer can compare the component's fingerprints against an existing set of fingerprints, or verify the component's digital signature.

In a presently preferred embodiment, an application-level user of a grid is unaware of all matters relating to application component authentication, as the grid functions transparently to normal operation of the node. The fact that a grid may be running in a mode that prohibits unauthenticated applications or data from being used is preferably transparent to the grid enabled application user. The user cannot vouch for the authenticity of the application component being used, as all signatures are traced back to a TTP.

To enable authentication of an application and its components by a node in the grid computing network, it can be a requirement that a developer of a grid-enabled application produce a fingerprint for each distributable component. A fingerprint will preferably include the name of the component along with a one-way hash of the component. These fingerprints can used to uniquely identify and guarantee the authenticity of each component. Securing the fingerprints prior to distribution is then the responsibility of the developer of a grid-enabled application. Securely distributing the fingerprints can be done during application distribution and peer configuration. Preventing local tampering of the fingerprint storage is the responsibility of the peer. If the local fingerprint storage is tampered, the node cannot execute applications, but no other adverse effects are created. Each release of the distributed computing environment can contain a fingerprint listing of all known grid-enabled applications and components, subject to application vendor approval. A new peer installation will not require an update to its fingerprint storage in order to authenticate existing applications and components. Existing applications being updated to a later version are used as a “springboard” to provide for the distribution of updated fingerprints. New applications will require the incorporation of their fingerprints into a legacy peer installation.

To enable authentication of an application and its components by a node, it can be an alternate requirement that a developer of a grid-enabled application produce a digital signature for each distributable component. A digital signature will be comprised of the encrypted one-way hash of the component plus the certificates and optionally the Certificate Revocation Lists (CRLs) needed to verify the value of the encrypted one-way hash. These digital signatures will used to uniquely identify and guarantee the authenticity of each component. There is then no need to ‘pre-distribute’ signature verification information prior to authentication as the digital signature will incorporate everything required to prove the authenticity of the signed component. Three different digital signature frameworks can be utilized. A scenario describing the behavior of each framework is given as follows: a trusted entity signs the components on behalf of the application vendor; a trusted entity issues code signing certificates to application vendors; and a trusted entity verifies the digital signature of a component against a preexisting, system-installed set of TTP (“trusted root”) certificates. Each digital signature framework has a different set of benefits and drawbacks, particular to its set-up and use. Table 1 provides a summary listing of advantages and disadvantages

TABLE 1

| | fingerprint | digital signature |
|---|---|---|
| pro | developers do not need, or are | analogous with a ‘zero- |
| | required to secure, any | configuration’ policy |
| | signing credentials | universally accepted |
| | locally enforceable revocation | authentication mechanism |
| | mechanism | single control seat revocation |
| | | mechanism |
| | | delegated trust model |
| | | (between ISV and TTP) |
| contra | requires protection from | greater sharing of risk between |
| | compromise of peer-local | platform vendor and ISV |
| | fingerprints | Platform vendor acts as either a |
| | non-standard authentication | “code-signing shop” or “a |
| | mechanism | Certificate Authority (CA)” |
| | installation/upgrade requires | peer cannot delegate digital |
| | the population of fingerprints | signature verification process |
| | on every peer | complex revocation mechanism |
| | no global revocation | involving remote connections |
| | mechanism | |

Application authentication involves the comparison of an application's credential (fingerprint or digital signature) against the source of the credential's binding. The source of a credential's binding for an application is the application binary itself. Access to the application binary must be trusted, and cannot involve direct interaction with the application itself.

Authentication of an application must occur before a job is started. The job control libraries, or job control application interface, can authenticate the calling application by determining which application binary was used to invoke it. Operating System routines can be used to determine which application context invoked the job control application interface, and which application binary the application context is associated with. A compromise of these Operating System routines does not indicate a security failure from the point-of-view of the peer. The peer can trust the Operating System without undue replication of critical routines provided by it.

Without application authentication, application components could be used by another application that is not authorized to do so. For instance, an application could control privileged or sensitive tasks without having a valid license. Application authentication allows an application developer to not have to validate a user's license within each application component. Trusted job control by an application can be used to satisfy valid license requirements within the context of the associated and trusted application components.

For embodiments of the present invention employing the generation of digital signatures, a “digital signature” certificate must be issued to the signing organization from a Certificate Authority (CA), which is described above as a trusted third party. The “digital signature” certificate binds the identity of an organization possessing a private key (PvK) intended for signing to its corresponding public key (PuK) used for verification. The PvK is used to sign all static components of the application such as applications (specifically the component explicitly using Job Control API), a task distributor plug-in; a task executor plug-in; and application data files. Two types of files are typically signed: 1) Java ARchives (JARs), and 2) non-JARs

Signed JARs can be produced using a conventional tool such as a “jarsigner” which produces an “enveloped” signature

Non-JARs can be produced using a grid specific tool used to produce a signature for a “non-JAR” file. The signature is preferably produced in accordance with RFC 3369 (which is incorporated herein by reference in its entirety) entitled “Cryptographic Message Syntax”. This is typically known as a “detached” or “external” signature

Digital Signature Verification is preferably performed in view of the following considerations. The root of trust used to verify the signature associated with the job components is derived from the “digital signature” certificate chain bound to the signature block. The list of trusted root certificates used by the peer to verify job component signatures is preferably managed by the local host. The peer will preferably not manage the list of trusted root certificates as peers cannot typically protect the integrity of CA certificates.

Digital signature verification of the application can be performed by a control class operator, in the object oriented paradigm, and the signature is verified during the control class initialisation. In the alternate, digital signature verification of the distributor can be performed by a Job class operator, and the signature is preferably verified prior to the loading of the distributor. Job distribution nodes 104 preferably maintain fingerprints of verified distributors, with the fingerprints preferably cached in memory only.

Digital signature verification of the executor is performed by task launcher 114, and verifies the signature prior to loading the interface of the executor. The peer preferably maintains fingerprints of verified interfaces cached only in-memory.

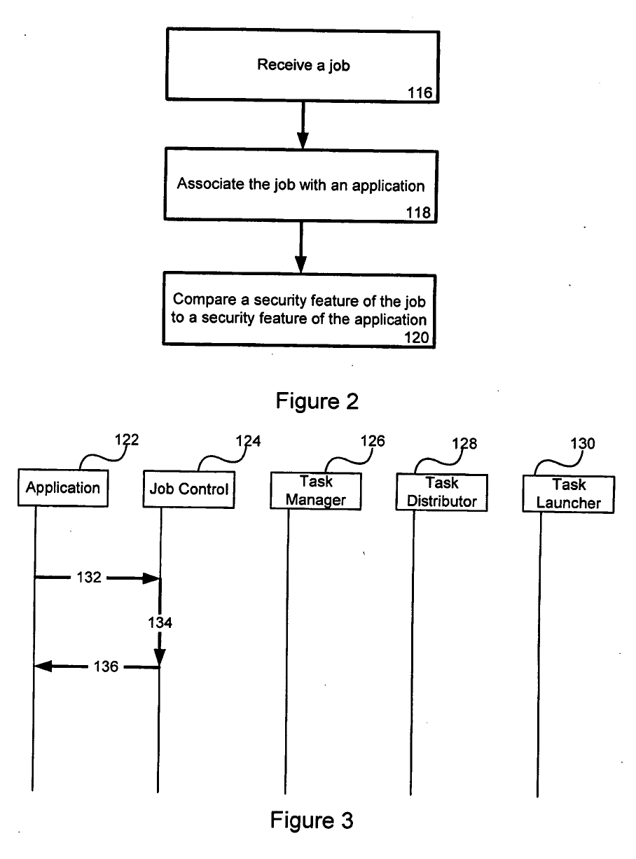

FIG. 2 illustrates a method of the present invention, whereby a node receives and authenticates a job. In step 116 the node receives the job. The job is associated with a locally stored application in step 118. In step 120, a security feature of the job is compared to a security feature of the application.

For a node that is submitting a job, such as application submission node 100, the job is received from a local input. The job has preferably been signed by a third party application so that its authenticity can be verified. For nodes that only support one distributed computing application, the step of associating the job to an application is reduced to a configuration setting that indicates that all jobs are related to a given application. For nodes that support a plurality of distributed applications, either a port over which the job is received, or an intrinsic property of the job can be used to associate the job with an application. When the application submission node 100 has associated the job with an application, a security feature of the job is authenticated against a security feature of the application. The security feature of the job can be a signature applied to the job, or a signature applied to a fingerprint of the job. Other such security features can be used, and will be apparent to those skilled in the art. The security feature of the application is preferably a public signature key or a verification certificate that allows for comparison to the security feature of the job. The security features must be complementary, or the comparison will result in an authentication failure. This allows the application submission node to authenticate that the job has been approved by a trusted entity, and the job can be submitted to the grid computing network upon completion of the authentication by sending it to a job distributor. If the authentication process results in a failure, a general error is generated. Failure of authentication will be discussed in greater detail below. Complementary security features indicate that the job can be authenticated as unmodified since application of the security feature. For public key signatures, complementary security features will result in the verification of the signature used to sign the job or job related data, such as a fingerprint, against a public key or verification certificate.

For a node that distributes job slices, such as job distribution node 104, the job is received from application submission node 100 in step 116. The job is then associated with its corresponding distribution application using the techniques described above in step 118. In step 120 a comparison of the security features of the job and the application is performed. If the comparison indicates that the security features match, the job is authenticated, and can be distributed to the execution node 112. If the authentication fails, an error message is generated.

From the perspective of execution node 112, in step 116 the job slice is received from distribution node 104. In step 118, the job is associated with a locally stored application as described above. In step 120, a comparison of the security features of the job and application is performed. If the comparison indicates that the security features match the job is authenticated, and can be executed. If the comparison results in an authentication failure, an error message is generated and passed back through the chain.

Failure to authenticate a job component indicates a corrupted signature, corrupted or unsigned jobs and job slices, or a host configuration error leading to the conclusion of a lack of root of trust. An application or application component could be signed using legitimately issued credentials yet fail to authenticate against a known root of trust; a root of trust can be unknown to the verifying host either because it is relatively new (“not yet configured”), or not a legitimate vendor of trust. Failing to authenticate has different effects depending on where the failure occurred. If an application fails to authenticate it is classified as a fatal error. The distributed job controller prevents the job from starting, the failure is logged, and the job controller notifies the submitter of the application. If a task distributor fails to authenticate it is classified as a fatal error. The job controller preferably aborts the job in progress, logs the failure and notifies the submitter of the application. If the Task Executor fails to authenticate it is classified as a non-fatal error. The task manager preferably removes the peer from the peer map, log the failure and notifies the submitter of the application

FIG. 3 illustrates an application authentication failure. The network includes elements from application submission node 100, job distribution node 104, and execution node 112. Application 122 and a Job control module 124 are both typically elements of the application submission node 100. Task manager 126 and task distributor 128 are typically elements of Job Distribution Node 104. The task launcher 130 is typically an element of the execution node 112. When an application is launched, application 122 sends a job start message 132 to job control 124. If job control 124 cannot authenticate the job, an application authentication failure 134 occurs, and a fatal process error 136 is generated and returned to the application.

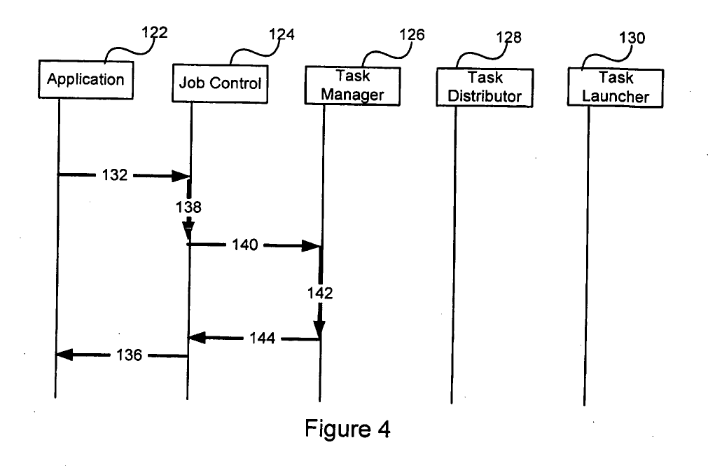

FIG. 4 illustrates a task distributor authentication failure. Once again, the network includes elements from application submission node 100, job distribution node 104, and execution node 112. Application 122 and a Job control module 124 are both typically elements of the application submission node 100. Task manager 126 and task distributor 128 are typically elements of Job Distribution Node 104. The task launcher 130 is typically an element of the execution node 112. When an application is launched, application 122 sends a job start message 132 to job control 124. The job is successfully authenticated, and is started. The job is sent to task manager 126 in message 140. Task manager 126 cannot authenticate either the job control application 124 or the job 140. As a result, a distributor authentication failure message 142 is generated. The distributor error 144 is returned to the job control 124, which sends message 136 back to application 122.

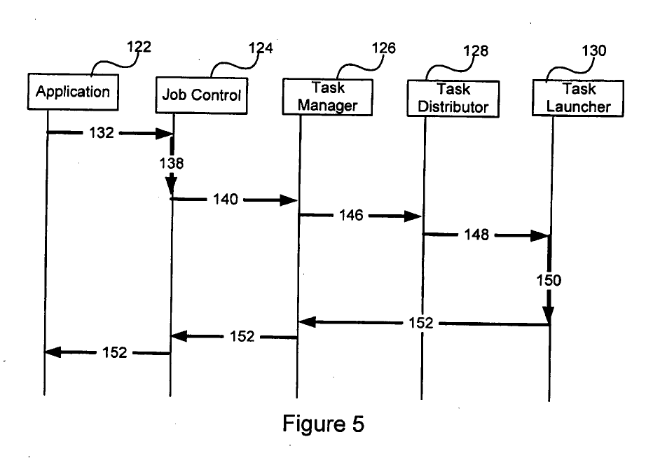

FIG. 5 illustrates a task executor authentication failure. Once again, the network includes elements from application submission node 100, job distribution node 104, and execution node 112. Application 122 and a Job control module 124 are both typically elements of the application submission node 100. Task manager 126 and task distributor 128 are typically elements of Job Distribution Node 104. The task launcher 130 is typically an element of the execution node 112. When an application is launched, application 122 sends a job start message 132 to job control 124. The job is successfully authenticated, and is started. The job is sent to task manager 126 in message 140. Task manager 126 successfully completes authentication. Authenticated job 146 is sent to task distributor 128, which sends job slice 148 to task launcher 130. Task launcher 130 attempts authentication and fails. This results in an executor authentication failure 150, and a task error message 152 is sent to the task manager 126. Task manager 126 forwards a message 152 to job control 124, which in turn forwards it to application 122.

A successful authentication along the entire chain, follows the same data flow as FIG. 5, up to the receipt of job slice 148 at task launcher 130. If task launcher 130 successfully authenticates the job slice, the slice is executed.

Signature security preferably includes verification of a signature associated with the configuration file, and provides a tool for signing the configuration file must be provided, as well as a method for protecting the signing credentials. The tool is preferably limited for use only by the local Administrator account. Protection of the signing credentials typically involves creating a password-less credentials store, where access is controlled based on inherent machine characteristics (CPU, HDD, etc.). Such an implementation can be used to store confidential information

One skilled in the art will appreciate that the nodes of the present invention can be implemented using standard computing devices. Logical functions of the device include an input, a comparator and a job engine. For each of the application submission node, the job distribution node and the job executor, the input receives the job, or job slice, and provides it to the comparator to determine if the security feature of the job is complementary to a known security feature, such as the security feature of a locally installed application. The job engine is used to act on the job according to the role of the node. Job submission nodes will use the job engine to slice the job and forward it to the job distribution nodes, job distribution nodes will use the job engine to distribute the job slices to the execution nodes, and the execution nodes will use the job engine to run the job slice.

The above-described embodiments of the present invention are intended to be examples only. Alterations, modifications and variations may be effected to the particular embodiments by those of skill in the art without departing from the scope of the invention, which is defined solely by the claims appended hereto.

1. A method of authenticating a job at one of a plurality of nodes in a grid computing network, the method comprising:
receiving a job at the node;
associating the job with a locally stored application in accordance with a job characteristic; and
comparing a security feature of the job with a security feature of the locally stored application.

2. The method of claim 1 wherein the step of receiving the job includes receiving a job at a local input for distribution to at least one of the plurality of nodes in the grid computing network.

3. The method of claim 2 wherein the step of comparing includes verifying that the job has been signed with a digital signature associated with the security feature associated with the locally stored application.

4. The method of claim 3, wherein the step of verifying includes determining that the job has been signed with a digital signature associated with one of a verification certificate and a public key associated with the locally stored application.

5. The method of claim 2, wherein the step of comparing includes verifying that a fingerprint of the job has been signed with a digital signature associated with one of a verification certificate and a public key associated with the locally stored application.

6. The method of claim 2 further including the step of forwarding the job to a job distribution node in the plurality of nodes when the comparison identifies complementary security features.

7. The method of claim 2 further including the step of generating an error message when the comparison fails to identify complementary security features.

8. The method of claim 1, wherein the step of receiving the job including receiving a job from an application submission node, in the plurality of nodes, for distribution, as job slices, to at least one other node in plurality of nodes.

9. The method of claim 8 wherein the step of comparing includes verifying that the security feature of the job is complementary to the security feature of the locally stored application.

10. The method of claim 8 further including the step of dividing the received job into job slices when the comparison identifies complementary security features.

11. The method of claim 10 further including the step of distributing the job slices to at least one of the plurality of nodes in the grid computing network.

12. The method of claim 8, further including the steps of:
generating an error message when the comparison fails to identify complementary security features; and
transmitting the generated error message to the application submission node.

13. The method of claim 8, wherein the step of receiving includes forming a connection to a job control module of the application distribution node and receiving the job over the formed connection.

14. The method of claim 13, wherein the step of comparing includes verifying that the job control module and the application have complementary security features.

15. The method of claim 1, wherein the step of receiving the job includes receiving a job slice from a job distribution node in the plurality of nodes.

16. The method of claim 15 wherein the step of comparing includes verifying that the security feature of the job and the security feature of the locally stored application are complementary.

17. The method of claim 15, further including the step of executing the job slice using the locally stored application when the comparison indicates complementary security features.

18. The method of claim 15, further including the steps of
generating an error message when the comparison fails to indicate complementary security features; and
transmitting the generated error message to the job distribution grid.

19. The method of claim 15 wherein the step of receiving includes forming a connection to a task distribution module of the job distribution node and receiving the job slice over the formed connection.

20. The method of claim 19, wherein the step of comparing includes verifying that the task distribution module and the locally stored application have complementary security features.

21. A node in a grid computing network, the node comprising:
an input for receiving a job;
a comparator for comparing a security feature associated with the job to a known security feature and generating a comparison message in accordance the comparison of the security features; and
job engine for acting on the job when the comparison message indicates the security features are complementary.

22. The node of claim 21, wherein the input includes means to receive the job from a local application, and the job engine includes means to separate the job into job slices and forward the job slices to another node in the grid computing network for distribution.

23. The node of claim 21, wherein the input includes means for receiving job slices for distribution, and the job engine includes means for distributing the job slices to at least one other node.

24. The node of claim 21, wherein the input includes means to receive a job slice and the job engine includes means for executing the job slice.

25. The node of claim 21 further including a message interface for transmitting error messages when the comparison signal indicates the security features are not complementary.
